(19) United States
(12) Patent Application Publication
(10) Pub. No.: US 2015/0000937 A1
(43) Pub. Date: Jan. 1, 2015

(54) Method for Dispersing a Gas Cloud and Apparatus for Carrying Out Said Method

(71) Applicant: Mirzhalil K. Usmanov, (US)

(72) Inventors: Mirzhalil K. USMANOV, Tashkent (UZ); Vadim L. KARPOV, Balashikha (RU); Vasily J. SHIMKO, Moscow (RU)

(21) Appl. No.: 14/107,075

(22) Filed: Dec. 16, 2013

Related U.S. Application Data
(63) Continuation of application No. PCT/UZ2012/000002, filed on Jun. 20, 2012.

(30) Foreign Application Priority Data
Jun. 28, 2011 (UZ) 20110268

(51) Int. Cl. A62C 3/06; A62C 2/08

(52) U.S. Cl. CPC A62C 3/06; A62C 2/08
USPC 169/45; 169/66

(57) ABSTRACT

An apparatus for dispersing a gas cloud has a solid fence mounted around the tank and at least one mesh fence on the upper edge of the fence. Sprayers on the header are oriented towards the fence and connected to a source of liquid. A cover with openings is mounted on the upper edge of the fence. Mounted pipes are in the openings. Gas detectors and heat radiation detectors are arranged between the tank and the fence and are connected to a system controlling supplying the liquid into the sprayers. If gas leaks from the tank, horizontal spreading of the gas cloud is restricted by creating a film of liquid on a mesh fence. The cloud is diluted with air to safe concentration by restricting the vertical spread of the cloud in the mesh fence and by dividing the cloud escaping from the zone into separate streams.

### RELATED APPLICATIONS

This application is a Continuation application of International Application PCT/UZ2012/000002, filed on Jun. 20, 2012 which in turn claims priority to Uzbek Application No. UZ20110268, filed Jun. 28, 2011, both of which are incorporated herein by reference in their entirety.

### FIELD OF THE INVENTION

The present invention relates to fire prevention methods and apparatus, and more particularly, to methods and apparatus for restricting the spread of gas clouds formed by leakage of flammable and explosive heavy gases from above-ground tanks, dispersing the said gas clouds to safe concentrations, and stopping the spread of fire if the said gas clouds ignite.

### BACKGROUND OF THE INVENTION

Inventor's Certificate of the USSR (No. 1695949 A1, IPC A 62 C 3/00) discloses an apparatus for preventing the development of emergency caused by leakage of flammable, explosive, and toxic gases and liquids from above-ground tanks designed for restricting the spread of said gases as well as vapours of said liquids and stopping the spread of fire if the gases and vapours ignite. This is realized by a method comprising the step of surrounding the said tank by a solid fence, which is made of a flexible and fireproof material, and folded inside a fire dike of the tank, by unfolding the said fence when an emergency situation occurs.

The said apparatus comprises a solid fence, which is made of a flexible and fireproof material and folded inside the fire dike of the above-ground tank, a lifting shell, which is connected to the said fence, a source of light gas, which is connected to the said shell by a hose, and gas detectors, which are placed by the said tank. In the case that the detectors come into action, the light gas (helium) from the light gas source is supplied into the lifting shell by the hose. The lifting shell moves upward carrying along the fence (unfolding the fence), and the tank becomes surrounded by this fence. The said fence, when it is unfolded, prevents the hazardous effect of gases and vapours on humans, equipment, and neighbouring tanks with flammable, explosive, and toxic gases and liquids; in this case the cloud of hazardous gases and vapours moves upward from the fenced zone and disperses over the fence.

The application of the said method and said apparatus for restricting the spread of gases and vapours and stopping the spread of fire (if the gases and vapours ignite) is not always effective. The reasons are:

The application of fireproof materials for making the fence without removal of heat from this fence (without cooling the fence) can leads to destroy of the fence in the case of ignition of gases. This is evident from the following: the fluoro-plastic (it is cited as an example of material for the fireproof fence in the said Inventor's Certificate) begins to melt slowly at a temperature of 327° C., and decomposes (transforms into a viscous-flow mass) at a temperature of 415° C.; while, for example, in the course of combustion of liquefied natural gas, which contains 75-99% of methane, the temperature of flame reaches 1,800° C.

When the gases explode in consequence of ignition, they immediately expand forming a shock-deformation pressure, and since the fence is solid, it fails under the pressure (the explosive pressure may run to 800-850 kPa).

The heavy gas cloud formed by leakage from the above-ground tank disperses poorly over the fence; outside the fence, most of the said cloud moves down, spreads over the site, and accumulates in natural and artificial hollows, semi-enclosed areas, and other similar zones.

Patent of the USSR No. 843704, IPC A 62 C 3/00, discloses an apparatus for dispersing a gas cloud formed by leakage of flammable and explosive heavy gases from above-ground tanks by a method comprising the step of forming a solid fence around the above-ground tank and a curtain of upward-directed steam jets over the said fence. The said solid fence prevents the horizontal spread of the gas cloud in the lower part of the tank. The said curtain prevents the horizontal spread of the gas cloud above the said solid fence and provides effective dispersion of the gas cloud by carrying along the gas cloud.

The said apparatus comprises a solid fence, which is placed around the tank, gas detectors, which produce signals to the fact that the concentration of gas in the gas cloud reaches a dangerous level, and also a source of steam. The solid fence has a header with openings. When the gas detectors detect dangerous gas concentration, the steam is supplied into the header, and a curtain of steam jets is formed over the solid fence.

The use of the said method and said apparatus can prevent the horizontal spread of a gas cloud and can disperse the gas, but it gives no way of preventing the spread of fire if the gas cloud ignited. (The ignition can occur as a result of some factors (e.g., a spark, etc.) in the zone surrounded by the steam curtain, or as a result of exposure to high-intensity heat radiation, which propagates from a fire centre lain outside this zone).

In addition, the said method and said apparatus are of limited application. The application of the said method and said apparatus for improvement of fire safety of above-ground tanks containing heavy gases is economically efficient only if there is a process steam. Because of that, small tanks (with a capacity up to 100 m³), which are placed at small capacity plants and population centres, are not equipped with apparatus for dispersing gas clouds, and therefore they present increased fire hazards.

### SUMMARY OF THE INVENTION

An object of the present invention is the improvement of fire safety of above-ground tanks, which contain flammable and explosive heavy gases, including the improvement of fire safety of small above-ground tanks (with a capacity up to 100 m³) by a way which is economical.

In accordance with the present invention, there is provided a method for dispersing a gas cloud formed by leakage from an above-ground tank, comprising the steps of restricting the horizontal spread of the said gas cloud and diluting thereof with air to safe concentrations, characterized in that the horizontal spread of the said gas cloud is restricted by creating a film of liquid on a mesh fence mounted around the said tank by sprinkling the said liquid on the said mesh fence, and the dilution of the said gas cloud with air to safe concentrations is carried out by restricting the vertical spread of the said gas cloud in the zone surrounded by the said mesh fence and dividing the gas cloud escaping from the said zone into separate streams.

The restriction of horizontal spread of the gas cloud by creating the said film on the said mesh fence takes place owing to the fact that this film is impenetrable to the gas cloud.

In addition to the restriction of the horizontal spread of the gas cloud, the said film formed on the mesh fence prevents the spread of fire, which results from the ignition of the gas cloud occurred without explosion in the zone surrounded by the mesh fence, and also prevents ignition of the said gas cloud under heat radiation of great intensity propagating from the fire centre that lies outside this zone. This takes place owing to the fact that the said film on the mesh fence does not evaporate on direct exposure to the flame or to the heat radiation with great intensity, and it also reduces the intensity of heat radiation (both from the ignited gas cloud and from an external fire centre) down to safe values.

The said film on the said mesh fence also prevents the spread of fire in the case when an explosive ignition of the gas cloud occurs in the zone surrounded by the mesh fence. This takes place owing to the fact that, when the blast wave affects the mesh fence, the said film on the said mesh fence breaks, and the excess pressure is released through the cells of the mesh fence; thereupon the integrity of the said film is restored, and the combustion of the gas cloud takes place in the said zone only, thereby preventing the fire from spreading.

Creating a film of liquid on the mesh fence and restricting the free vertical spread of the gas cloud in the zone surrounded by the mesh fence results in a cut in oxygen supply into the combustion area, and the combustion of the gas cloud dies down, which prevents the development of emergency and the destruction of the gas-containing tank.

Restricting the free vertical spread of the gas cloud in the zone surrounded by the said mesh fence and dividing the gas cloud that escapes from this zone into separate streams provide a reduction of density of the gas cloud and an effective mixture thereof with the ambient air (dilution with air) reducing the concentration of gas in the gas cloud down to safe concentration. This is due to the following:

The temperature of the gas cloud formed by leakage of heavy gas from the above-ground tank where the gas is contained in a liquefied state is significantly below the ambient temperature (for example, the boiling point of natural gases in the liquefied state lies in the range from −158 to −163° C.), and therefore, the gas cloud that forms by leakage of gas from the above-ground tank heats up owing to the convective heat exchange between the surrounding medium and this gas cloud, with result that the density of this gas cloud falls. When the gas cloud is divided into separate streams, the convective heat exchange between the surrounding medium and the gas cloud becomes faster owing to the increase in their contact area, resulting in a faster decrease of the density of this gas cloud.

In response to the restriction of the vertical spread of the gas cloud in the zone surrounded by the mesh fence, the pressure in this gas cloud increases, as a result of which the speed of the gas cloud in the said gas cloud streams also increases, which leads to an increase in the efficiency of heat exchange between the surrounding medium and this gas cloud and to an effective mixing of this gas cloud with air (dilution with air).

In accordance with the present invention, there is also provided an apparatus for dispersing a gas cloud formed by leakage from an above-ground tank, comprising a solid fence, which is mounted around the said above-ground tank, gas detectors, which are arranged between the said above-ground tank and said solid fence and connected to a control system, and a header with openings, characterized in that, on the upper edge of the said solid fence, there is mounted at least one mesh fence, on the upper edge of the said mesh fence, there is a cover with openings, in the said cover openings, there are mounted pipes, the said header is connected to the source of liquid, and in the openings of the said header, there are mounted sprayers, which are oriented towards the said mesh fence.

The said apparatus can include two mesh fences mounted with a gap relatively to one another, wherein the header with sprayers is placed between the said fences.

The said apparatus can include heat radiation detectors, which are arranged between the mesh fence and the above-ground tank, and connected to the control system.

Under normal conditions of operation (without a liquid film on the mesh fence), the mesh fence is aerated, and insignificant gas vapours produced in the process disperse without formation of flammable and explosive clouds of the gas.

The said gas detectors signal the control system when a dangerous gas concentration appears. As this takes place, the control system issues an instruction to the executive device and the executive device supplies liquid to the header from the source of liquid.

The sprayers, mounted in the openings of the header, spray the liquid onto the mesh fence creating a liquid film on this mesh fence in such a way that:

the said mesh fence becomes impenetrable to the gas cloud;

in the case of the ignition of the gas cloud in the zone surrounded by the mesh fence, the fire is prevented from spreading beyond the mesh fence;

the gas cloud is not ignited when the mesh fence is exposed to intense heat radiation from a heat radiation source lain outside the zone surrounded by the mesh fence.

Water is used as the liquid in warm seasons and antifreeze is used as the liquid in cold seasons.

The cover restricts the free vertical spread of the gas cloud in the zone surrounded by the mesh fence. When the liquid film exists on the mesh fence, an elevated pressure is created in the gas cloud. Under this pressure, the gas cloud escapes from this zone through the openings with an increased speed.

The pipes mounted in the cover openings divide the gas cloud escaping from the enclosed zone between the mesh fence and the cover into separate streams; in so doing, the density of the gas cloud decreases due to the increase in the efficiency of heat exchange between the surrounding medium and this gas cloud when it moves through the pipes and due to the effective mixing of the gas cloud with air (dilution with air) when this gas cloud exits the pipes, with result that the concentration of gas in the gas cloud reduces down to safe concentration.

The heat radiation detectors signal that the dangerously intense heat radiation affects the apparatus from the fire sources lain outside the apparatus. These detectors are connected to the control system just like the gas detectors. When the control system receives a signal from the heat radiation detectors, it issues an instruction to the executive device. The executive device supplies liquid to the sprayers and a liquid film is formed on the mesh fence, which bring down the intensity of the affecting heat radiation to safe values. Thus, in addition to solving the problem of dispersing the gas clouds formed by leakage of heavy gases from the above-ground tanks, the apparatus also solves the problem of protecting the tank together with its equipment, pipelines, and pipe fittings contained in the zone surrounded by the mesh fence from the dangerous effects of heat radiation during the entire life of the tank improving the fire safety thereof.

### BRIEF DESCRIPTION OF THE DRAWINGS

The present invention will be described with reference to the accompanying drawings, where:

FIG. 1 shows an embodiment of the apparatus with one mesh fence for the dispersion of the gas cloud formed during leakage of heavy gases from an above-ground tank; the pipes mounted in the openings of the cover and the header with sprayers are not shown;

FIG. 2 shows the view A in FIG. 1;

FIG. 3 shows the position of the pipes on the cover of the apparatus;

FIG. 4 shows an embodiment of the apparatus with two mesh fences (front view); the pipes mounted in the openings of the cover are not shown;

FIG. 5 shows the sectional view B-B in FIG. 4.

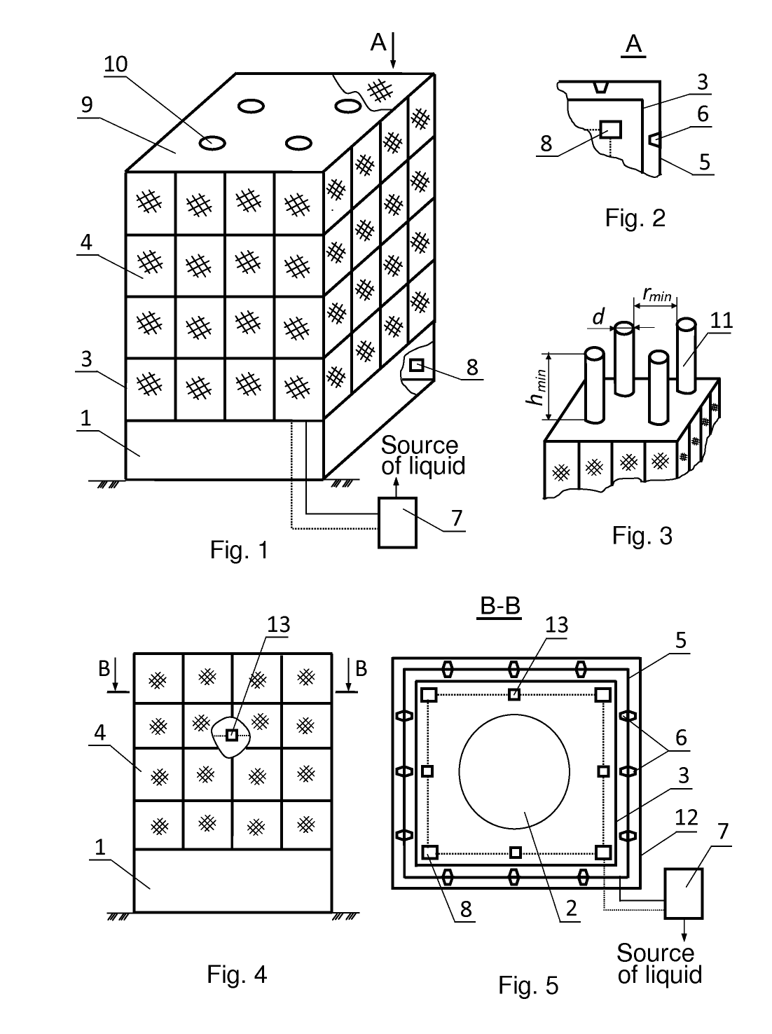

### DETAILED DESCRIPTION OF THE PREFERRED EMBODIMENTS

The method for dispersing a gas cloud according to the present invention can be carried out in an apparatus comprising a solid fence 1 mounted around an above-ground tank 2 containing a heavy gas. On the upper edge of the solid fence 1, it is mounted a mesh fence comprising a frame 3 in the shape of a rectangular prism with mesh panels 4 attached thereupon (these panels comprise mesh wire and frame made of metal or other material). A header 5 with openings is attached to the frame 3 of the said mesh fence. In the openings of the header 5, there are mounted sprayers 6, which are oriented towards the mesh panels 4. The header 5 is connected to a source of liquid (not shown) via a control system 7. Between the tank 2 and the solid fence 1, there are mounted gas detectors 8 designed to inform about the fact that the dangerous gas concentration is developed in the gas cloud. The gas detectors 8 are connected to the control system 7. On the upper edge of the frame 3 of the mesh fence, there is attached a cover 9 having openings 10. In the openings 10, there are mounted pipes 11.

The minimum height hₘᵢₙ of the pipes 11 and the minimum distance rₘᵢₙ between these pipes are chosen so that effective dispersion of the gas cloud takes place (once the gas cloud has been dispersed, maximum ground level concentration of the heavy gas in the gas cloud does not exceed 20% of their lower flammable limit (LFL). Values of hₘᵢₙ, and rₘᵢₙ are calculated with the equations:

$$\begin{matrix}{h}_{min} = \frac{175 d}{{C}_{LFL}} {( \frac{ρ}{{ρ}_{∞}} )}^{0.5} ; & ( 1 ) \\ {r}_{min} = \frac{110 d}{{C}_{LFL}} {( \frac{{ρ}_{∞}}{ρ} )}^{0.5} , & ( 2 )\end{matrix}$$

where:

hₘᵢₙ, is the minimum height of the pipe, m;

rₘᵢₙ is the minimum distance between the pipes, m;

d is the diameter of the pipe;

C_{LFL} is the lower flammable limit (LFL), %;

ρ is the density of the gas at the exit from the pipe; kg/m³;

ρ_{∞} is the density of ambient air, kg/m³.

When the apparatus of the present invention is used for dispersing the liquefied natural gas that forms by leakage from an above-ground tank, the minimum height hₘᵢₙ of the pipes 11 and the minimum distance rₘᵢₙ between these pipes have the following values: hₘᵢₙ=2.7 m, rₘᵢₙ=2.8 m (these values are calculated with the equations 1 and 2 taking d=0.1 m, C_{LFL}=5%, the ambient air temperature equal to 20° C., the gas cloud temperature equal to −20° C., ρ_{∞}=1.293 kg/m³, ρ=0.776 kg/m³).

The method for dispersing a gas cloud according to the present invention can be carried out in an apparatus comprising two wire mesh fences mounted with a gap between one another that equals to 120 mm These fences are formed by frames 3 and 12, to which the mesh panels 4 are attached. In this apparatus the header 5 with the sprayers 6 is placed between the frames 3 and 12.

Heat radiation detectors 13, which signal that the dangerously intense heat radiation affects the apparatus from the outside, are connected to the control system 7, as well as the gas detectors 8.

The above-described embodiments of the apparatus according to the present invention have been cited as examples only, and in no way they are limiting the scope of all possible embodiments. In particular, the mesh fences of this apparatus may have another shape (cylinder, truncated cone, truncated pyramid, etc.).

The methods for dispersing the gas cloud formed by leakage from an above-ground tank is carried out as follows:

When an emergency situation occurs because of gas leakage from the tank 2, the gas detectors 8 signal that a dangerous concentration of gas takes place; the control system 7 turns on the supply of the liquid (for example, water) from the source of liquid; the liquid is sent to header 5 and from the openings in header 5 enters the sprayers 6, which spray it over one mesh fence with the frame 3 and panels 4 or over two mesh fences with the frames 3 and 12 and panels 4. As a result, a steady film of the liquid is formed on the said mesh fences. The liquid is supplied into header 5 under pressure 0.4 MPa; in so doing, the consumption of the liquid is 0.1 litres per second for one square metre of the mesh panels 4. Once the film of liquid has been formed on the said mesh fences, they become impenetrable to the gas cloud, and together with the solid fence 1, they prevent the horizontal spread of the gas cloud. The liquefied gas leaking from the tank has a low boiling point, and therefore it evaporates intensively. Because of that the gas cloud formed by leakage from the tank moves up within the zone restricted by the mesh fence and the film of liquid (for example, the boiling point of the liquefied natural gas is in the range from −158° C. to −163° C.). Since the cover 9 with the pipes 11 restricts the free upward spread of the gas cloud, the pressure in this gas cloud increases, and the said gas cloud escapes outward through the said pipes 11. When the gas cloud moves in the pipes 11, because of the convective heat exchange, the temperature of the gas cloud increases (at the exit from the pipes, it is in the range from 0° C. to −20° C. depending on the season), and the density of this gas cloud decreases (at the exit from the pipes, it is in the range from 0.717 to 0.776 kg/m³). In so doing the gas cloud escaping from the pipes mixes effectively with the ambient air, and the concentration thereof reaches safe values.

### INDUSTRIAL APPLICABILITY

The method for dispersing a gas cloud formed by leakage from an above-ground tank will have applications in all manufacturing or industrial facilities and all population centres where above-ground storage tanks containing flammable and explosive heavy gases (including small capacity tanks, up to 100 m³) are placed.

What is claimed is:

1. A method for dispersing a gas cloud formed by leakage from an above ground tank, the method comprising:
sprinkling a liquid on a mesh fence mounted around the said tank to create a film of liquid on the mesh fence to restrict a horizontal spread of the gas cloud; and
restricting the horizontal spread of the gas cloud and diluting thereof with air to safe concentrations, wherein diluting of the gas cloud with air to safe concentrations comprises restricting a vertical spread of the gas cloud in a zone surrounded by the said mesh fence and dividing the gas cloud escaping from said zone into separate streams.

2. An apparatus for dispersing a gas cloud formed by leakage from an above-ground tank, the apparatus comprising:
a solid fence mounted around the above-ground tank, the solid fence comprising an upper edge;
gas detectors arranged between the above-ground tank and the solid fence and connected to a control system;
a header connected to a source of a liquid, the header comprising openings with mounted sprayers disposed in the openings, the sprayers being oriented towards the mesh fence;
at least one mesh fence mounted on the upper edge of the solid fence, the at least one mesh fence comprising its upper edge on which upper edge a cover with openings is mounted; and
mounted pipes in the openings of the cover.

3. The apparatus according to claim 2, wherein two mesh fences separated by a gap are mounted on the upper edge of the solid fence, and wherein the header is placed between the two mesh fences.

4. The apparatus according to claim 2, further comprising heat radiation detectors disposed between the tank and the at least one mesh fence, the heat radiation detectors being connected to the control system.
